(19) United States
(12) Patent Application Publication
(10) Pub. No.: US 2017/0102305 A1
(43) Pub. Date: Apr. 13, 2017

(54) HARDNESS TESTING APPARATUS AND INDENTER OF HARDNESS TESTING APPARATUS

(71) Applicant: MITUTOYO CORPORATION, Kanagawa (JP)

(72) Inventors: Masaharu TSUJII, Yamato (JP); Satoko MORI, Yamato (JP); Takayuki YAMADA, Yamato (JP)

(73) Assignee: MITUTOYO CORPORATION, Kanagawa (JP)

(21) Appl. No.: 15/281,349

(22) Filed: Sep. 30, 2016

(30) Foreign Application Priority Data
Oct. 9, 2015 (JP) 2015-200648

(51) Int. Cl. G01N 3/42

(52) U.S. Cl. CPC G01N 3/42; G01N 2203/005; G01N 2203/0078; G01N 2203/0098

(57) ABSTRACT

A hardness tester loads a predetermined test force on an indenter and presses into a surface of a sample to form an indentation. The indenter includes an indenter memory storing indenter information specific to the indenter. The indenter is detachably mounted to an indenter shaft. A CPU acquires, from the indenter memory, the indenter information of the indenter mounted to the indenter shaft, and uses the acquired indenter information to perform a predetermined operation and calculate hardness.

### CROSS-REFERENCE TO RELATED APPLICATIONS

The present application claims priority under 35 U.S.C. §119 of Japanese Application No. 2015-200648, filed on Oct. 9, 2015, the disclosure of which is expressly incorporated by reference herein in its entirety.

### BACKGROUND OF THE INVENTION

1. Field of the Invention

The present invention relates to a hardness tester and to an indenter used in the hardness tester.

2. Description of Related Art

A hardness tester is known which is capable of calculating values for various material characteristics by pressing an indenter into a surface of a sample to form an indentation and continuously measuring a indentation depth of the indenter during formation of the indentation. In the hardness tester of this type, the indentation depth of the indenter is continuously measured. Therefore, calculation of the values for various material characteristics requires corrections to a shape of a forefront end of the indenter being used. However, conventionally, operations have been carried out with a user identifying the shape of the indenter by relying on a number engraved in the indenter, and calculating and inputting correction values for that indenter.

As a hardness tester readily and reliably identifying an indenter to be used, a hardness tester has been proposed in which an indenter includes an identifier capable of identifying the indenter, and when the indenter is mounted to an indenter attachment portion, the hardness tester acquires identification information from the identifier and identifies the indenter (see, for example, Japanese Patent Laid-open Publication No. 2006-71415).

However, the hardness tester of Japanese Patent Laid-open Publication No. 2006-71415 only enables automatic identification of an indenter. Therefore, when attempting to carry out hardness testing using the indenter with a hardness tester other than the prescribed hardness tester, in which correction values have already been defined, a user must once again manually input the correction values correcting the shape of the forefront end of the indenter, which imposes a burden on the user.

### SUMMARY OF THE INVENTION

The present invention improves operability for a user when swapping out an indenter for use in a hardness tester using a detachable indenter.

According to one aspect of the present invention, a hardness tester loads a predetermined test force on an indenter and presses into a surface of a sample to form an indentation. The indenter includes an indenter memory storing indenter information specific to the indenter. The hardness tester includes an indenter attachment portion to which the indenter is detachably mounted; an acquirer acquiring, from the indenter memory, the indenter information of the indenter mounted to the indenter attachment portion; and a hardness calculator using the indenter information acquired by the acquirer, performing a predetermined operation, and calculating hardness.

According to another aspect of the present invention, the indenter includes an indenter main body and a holder holding the indenter main body. The indenter memory is installed within the holder.

According to another aspect of the present invention, the indenter information includes correction parameters correcting a shape of the indenter to an ideal shape in the predetermined operation, and the hardness calculator performs the predetermined operation using the correction parameters acquired by the acquirer.

According to another aspect of the present invention, the indenter type is included in the indenter information. The hardness tester includes an equation memory, which associates and stores the indenter type with an equation calculating hardness. The hardness calculator selects an equation from the equation memory in accordance with the indenter type acquired by the acquirer and performs the predetermined operation.

According to another aspect of the present invention, an indenter used in a hardness tester is detachable with respect to the hardness tester, and includes an indenter memory storing indenter information specific to the indenter.

According to another aspect of the present invention, the indenter includes an indenter main body and a holder holding the indenter main body. The indenter memory is installed within the holder.

According to another aspect of the present invention, the indenter information includes correction parameters correcting a shape of the indenter to an ideal shape in a predetermined operation calculating hardness.

According to another aspect of the present invention, the indenter information includes the indenter type.

According to the present invention, operability for a user can be improved when swapping out an indenter for use in a hardness tester using a detachable indenter.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view illustrating a hardness tester according to the present invention;

FIG. 2 is a block diagram of a control structure of the hardness tester of FIG. 1;

FIGS. 3A and 3B are exemplary lateral cross-sectional views of an indenter mounted to the hardness tester of FIG. 1;

FIG. 4 is an exemplary table of correction parameters;

FIG. 5 is an exemplary pressing indentation curve; and

FIG. 6 is a flow chart illustrating a hardness testing process of the hardness tester.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereafter, a hardness tester according to the present invention is described in detail with reference to the drawings.

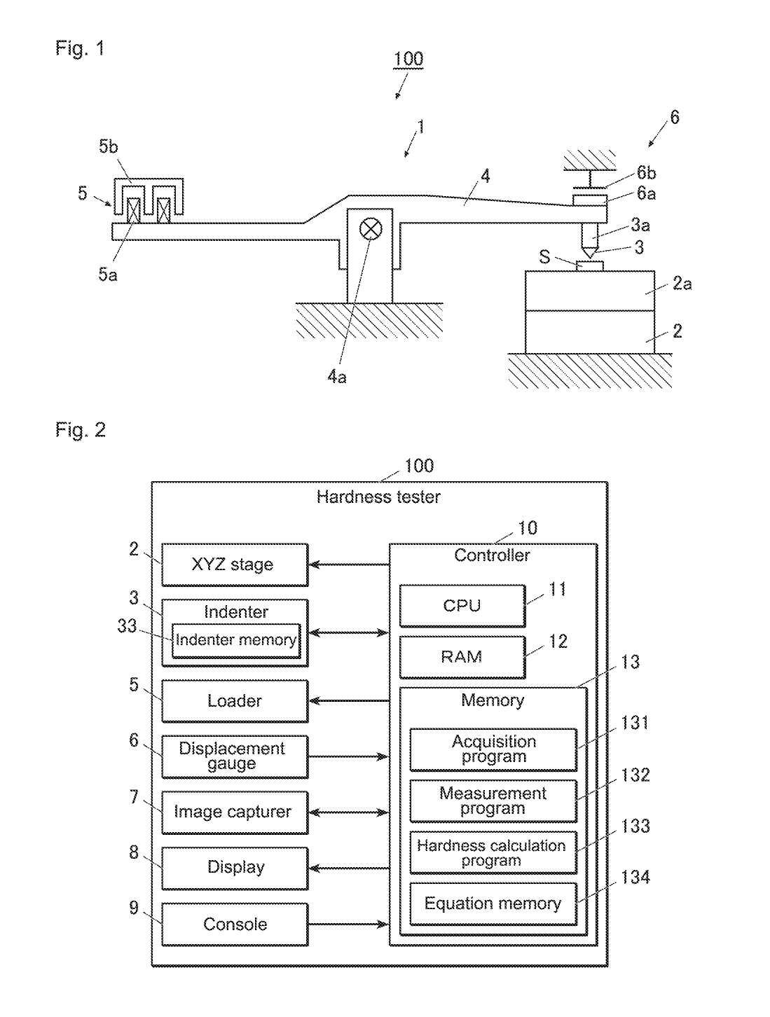

FIG. 1 is a schematic view illustrating a hardness tester according to the present invention. FIG. 2 is a block diagram of a control structure of the hardness tester of FIG. 1. A hardness tester 100 according to the present embodiment is an instrumented indentation test for hardness capable of continuously monitoring a load placed on an indenter 3 (test force) and a displacement amount of the indenter 3 (indentation depth).

As shown in FIGS. 1 and 2, for example, the hardness tester 100 includes a hardness tester main body 1 to which each component is provided and a controller 10 performing all-inclusive control of the hardness tester main body 1.

The hardness tester main body 1 includes, as an indentation formation mechanism, an XYZ stage (sample stage) 2 displacing a sample S in X, Y, and Z directions; a load lever 4 having at one end thereof an indenter 3, which forms an indentation in the sample S; a loader 5 placing a predetermined load (test force) on the load lever 4; a displacement gauge 6 detecting an amount of displacement of the indenter 3; an image capturer 7 capturing an image of the indentation formed on a surface of the sample S; a display 8; and a console 9.

The XYZ stage 2 is configured to displace in X, Y, and Z directions (i.e., in horizontal and vertical directions) according to a control signal input from the controller 10. The sample S is displaced forward/backward, to the left/right, and upward/downward by the XYZ stage 2 so as to adjust a position of the sample S with respect to the indenter 3. In addition, the XYZ stage 2 holds the sample S with a sample holding stage 2a such that the sample S resting on an upper surface thereof does not shift during test measurement.

The indenter 3 is provided so as to be vertically displaceable above the XYZ stage 2, on which the sample S is placed. A predetermined load is provided to the indenter 3 and an indenter main body 31 is pressed vertically into a top surface of the sample S, at which point an indentation is formed in the top surface of the sample S.

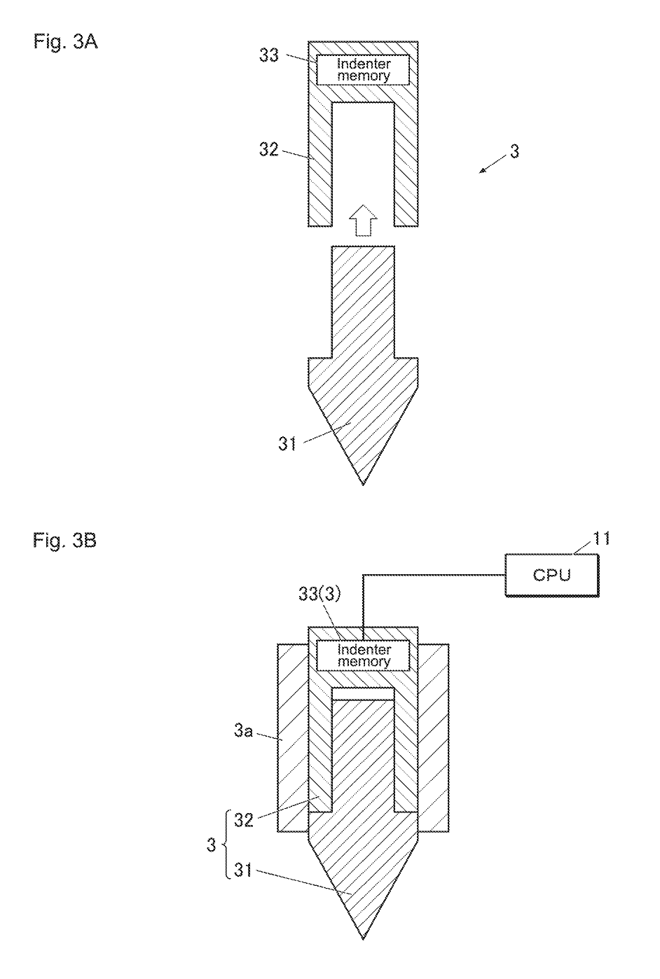

FIGS. 3A and 3B are exemplary lateral cross-sectional views of the indenter 3, which is mounted to the hardness tester 100. For example, as shown in FIG. 3A, the indenter 3 includes the indenter main body 31, which is pressed into the sample S; a holder 32, which the indenter main body 31 is pressed into and which holds the indenter main body 31; and an indenter memory 33 installed in the holder 32.

The indenter main body 31 has a forefront end portion (bottom end portion) formed in a shape prescribed by various indenters such as, for example, a Vickers, Berkovic, Rockwell, Knoop, or Brinnell indenter. FIG. 3A illustrates an example where the forefront end of the indenter main body 31 is formed in a pyramid shape. Such an indenter main body 31 is detachably held by the holder 32 by pressing a rear end portion (top end portion) of the indenter main body 31 into the holder 32. The indenter main body 31 is detachable with respect to the holder 32. Therefore, in cases where the forefront end of the indenter main body 31 becomes worn or damaged, it is possible to replace only the indenter main body 31.

The holder 32 is a cylindrical member having an interior space capable of accommodating the rear end portion of the indenter main body 31. The rear end of the indenter main body 31 is pressed in through the bottom end of the holder 32. In a state where the indenter main body 31 is held by the holder 32, the top end portion of the holder 32 is detachably fixated to an indenter shaft (indenter attachment portion or indenter mount) 3a by a screw, for example. Thus, when the indenter 3 (holder 32) is mounted to the indenter shaft 3a, a connection terminal provided to the top end portion of the holder 32 and a connection terminal provided to the indenter shaft 3a are electrically connected, enabling transfer of indenter information (described later).

The indenter memory 33 is configured by a non-volatile memory, for example. Indenter information specific to the indenter, such as the type of indenter, correction parameters, and the like, is stored in the indenter memory 33. In this example, the type of indenter indicates the type to which the indenter 3 belongs and specifies any of the various kinds of indenters used in hardness testers such as Vickers, Berkovic, Rockwell, Knoop, and Brinnell hardness testers. Also, the correction parameters are correction values to correct the shape of the indenter 3 (shape of the forefront end portion of the indenter main body 31) to an ideal shape when performing hardness calculations. The “ideal shape” refers to the shape of a forefront end of the indenter main body 31 that conforms to design values. In general, making the shape of the forefront end of the indenter main body 31 into the ideal shape (conforming to the design values) is difficult, and in reality the forefront end of the indenter main body 31 may curve or have skewed dihedral angles. Therefore, when performing the hardness calculations described below, a surface area (Aₛ) of the indenter 3 and a projected contact area (Aₚ) are corrected using correction parameters specific to the indenter 3.

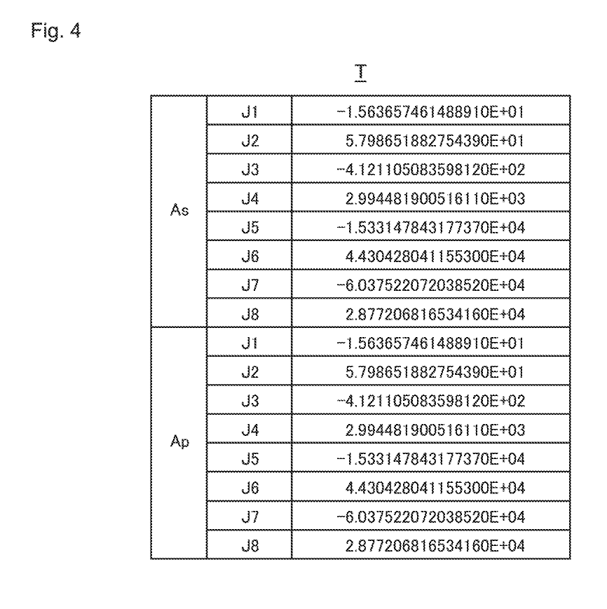

FIG. 4 shows a table T illustrating exemplary correction parameters. In the example of FIG. 4, table T stores correction parameters J₁ to J₈ used in operations (formula (2) below) to calculate the surface area (Aₛ) of the indenter 3 calculated from the maximum indentation depth; and correction parameters J₁ to J₈ used in operations (formulae (4) and (5) below) to calculate the projected contact area (Aₚ) between the indenter 3 and the sample S at maximum pressing. Such correction parameters are calculated ahead of time by the user and are stored in the indenter memory 33 for each indenter 3.

Returning to FIGS. 1 and 2, the load lever 4 is, for example, formed to be substantially pole-shaped. The load lever 4 is fixed at an approximately central portion thereof atop a stand via a cross spring 4a. The indenter 3 is provided at a first end of the load lever 4 so as to freely contact and separate from the sample S from above, the sample S resting atop the sample holding stage 2a. The indenter 3 presses against the surface of the sample S to form the indentation therein. At a second end of the load lever 4, a force coil 5a is provided, configuring the loader 5. The loader 5 is, for example, a force motor and includes the force coil 5a attached to the load lever 4 and a fixed magnet 5b fixed so as to oppose the force coil 5a. According to a control signal input from the controller 10, for example, the loader 5 employs a driving force to rotate the load lever 4, for example. The driving force is a force generated by electromagnetic induction between a magnetic field created in a gap by the fixed magnet 5b and an electric current flowing in the force coil 5a, which is positioned inside the gap. By rotating the load lever 4, the end of the load lever 4 on the indenter 3 side tilts downward and the indenter 3 is pressed into the sample S.

The displacement gauge 6 is, for example, an electrostatic capacitance-type displacement sensor and includes a movable polar plate 6a provided to an end of the load lever 4 on the indenter 3 side and a fixed polar plate 6b fixed in place so as to oppose the movable polar plate 6a. For example, the displacement gauge 6 detects a variation in electrostatic capacitance between the movable polar plate 6a and the fixed polar plate 6b, and thus detects the amount of displacement when the indenter 3 forms the indentation in the sample S (indentation depth when the indenter 3 is pressed into the sample S). A displacement signal based on the detected amount of displacement is then output to the controller 10. Moreover, the electrostatic capacitance-type displacement sensor is offered as an exemplary displacement gauge 6; however, the displacement gauge 6 is not limited to this and may, for example, be an optical-type displacement sensor or an eddy current-type displacement sensor.

The image capturer 7 includes, for example, a camera and captures an image of the indentation formed on the surface of the sample S by the indenter 3 atop the sample holding stage 2a, for example, according to a control signal input from the controller 10.

The display 8 is, for example, a liquid crystal display panel and performs display processing of the image of the surface of the sample S captured by the image capturer 7, various kinds of test results, and the like according to a control signal input from the controller 10.

The console 9 is, for example, a group of operation keys such as in a keyboard and, when operated by the user, outputs an operation signal associated with that operation to the controller 10. Moreover, the console 9 may also include a pointing device such as a mouse or a touch screen, a remote control, and other operation devices. The console 9 may be operated when the user performs an instruction input to perform hardness testing on the sample S, when the user defines the test force (i.e., the load) placed on the indenter 3, and the like.

The controller 10 includes a CPU (Central Processing Unit) 11, a RAM (Random Access Memory) 12, and a memory 13. Through a system bus or the like, the controller 10 is connected to the XYZ stage 2, the indenter 3, the loader 5, the displacement gauge 6, the image capturer 7, the display 8, and the console 9, for example.

The CPU 11 performs various control processes according to various processing programs for use in the hardness tester that are stored in the memory 13, for example.

The RAM 12, for example, includes a program storage region for extracting the processing programs executed by the CPU 11 and a data storage region storing input data or processing results generated when the processing programs are executed.

The memory 13, for example, stores a system program executable by the hardness tester 100; various kinds of processing programs executable by the system program; data to be used when the various kinds of processing programs are executed; and data on results of the various processes calculated by the CPU 11. Moreover, programs are stored in the memory 13 in the form of a programming code that is readable by the computer. Specifically, the memory 13 stores an acquisition program 131, a measurement program 132, a hardness calculation program 133, and an equation memory 134, for example.

The acquisition program 131 is a program allowing the CPU 11 to acquire the indenter information stored in the indenter memory 33 of the indenter 3, for example. Specifically, when the indenter 3 is mounted to (electrically connected to) the hardness tester 100, the CPU 11 executes the acquisition program 131 and acquires the type of indenter, the correction parameters (J₁ to J₈), and the like from the indenter memory 33 of the indenter 3 as indenter information. By executing the acquisition program 131 of this kind, the CPU 11 is an acquirer.

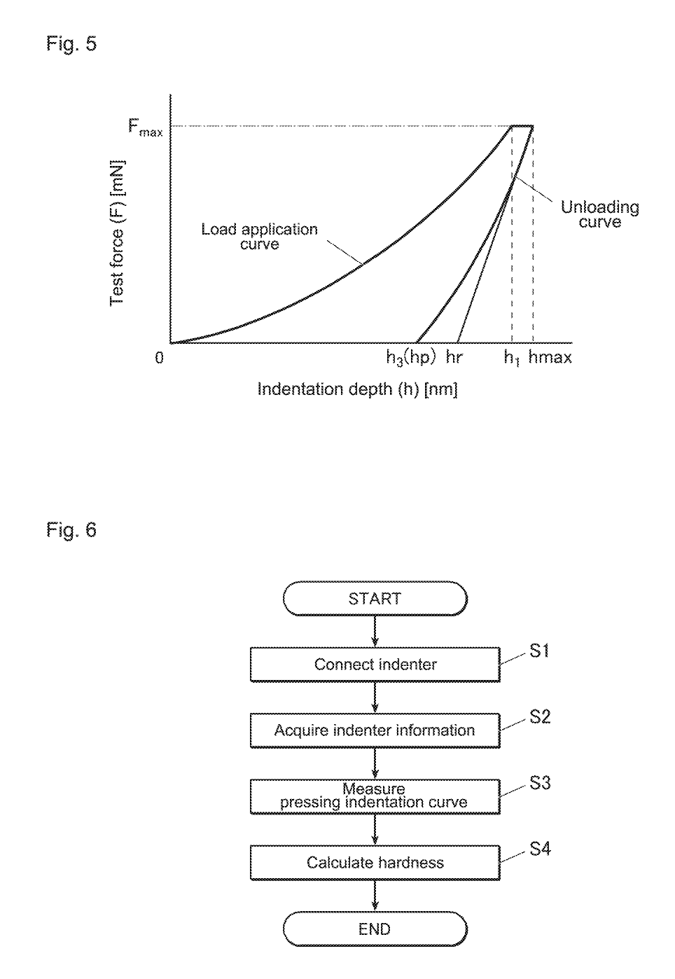

The measurement program 132 is a program allowing the CPU 11 to provide the predetermined load to the indenter 3 and press the indenter 3 into the surface of the sample S to form an indentation; and to measure a pressing indentation curve which detects the amount of displacement of the indenter 3 (indentation depth (h)) and the test force (F) loaded on the indenter 3 during formation of the indentation, for example. Specifically, when the user provides an instruction input to the console 9 to perform hardness testing of the sample S, the CPU 11 responds by executing the measurement program 132, then executes the instrumented indentation test on the sample S and performs measurement of the pressing indentation curve. FIG. 5 is an exemplary pressing indentation curve. Upon forming an indentation, the pressing indentation curve is obtained by gradually increasing a load applied to the indenter 3 until a defined maximum test force (Fₘₐₓ) is reached (load application) and measuring a load application curve; and also, after the load applied to the indenter 3 reaches the maximum test force, by gradually decreasing the load applied to the indenter 3 (load removal) and measuring a unloading curve.

The hardness calculation program 133 is a program allowing the CPU 11 to perform a predetermined operation using the acquired indenter information and to calculate hardness. Specifically, the CPU 11 selects an equation from the equation memory 134 in response to the type of indenter in the indenter information acquired by running the acquisition program 131. In addition, the CPU 11 substitutes the correction parameters (J₁ to J₈) from the acquired indenter information into the selected equation, carries out the operation, and calculates the hardness. By executing the hardness calculation program 133 of this kind, the CPU 11 is a hardness calculator.

The equation memory 134 associates and stores the type of indenter and an equation calculating hardness, for example.

Specifically, in a case where Martens hardness (HM) is calculated, for example, equations represented by the following Formula (1) and Formula (2) are associated with a Berkovic indenter and a Vickers indenter and then stored.

$$\begin{matrix}[ Formula 1 ] & \\ HM = \frac{{F}_{max}}{{A}_{S} ( {h}_{max} )} & ( 1 )\end{matrix}$$

[Formula 2]

Aₛ(hₘₐₓ)=26.43hₘₐₓ²+J₁hₘₐₓ+J₂hₘₐₓ^{1/2}+J₃hₘₐₓ^{1/4}+J₄hₘₐₓ^{1/8}+J₅hₘₐₓ^{1/16}+J₆hₘₐₓ^{1/32}+J₇hₘₐₓ^{1/64}+J₈hₘₐₓ^{1/128} (2)

In this example, Fₘₐₓ(N) is the maximum test force. Aₛ(hₘₐₓ) is a surface area of an indenter calculated from the maximum indentation depth. Also, J₁ to J₈ are the correction parameters.

In addition, in a case where indentation hardness (H_{IT}) is calculated, for example, equations represented by the following Formula (3) and Formula (4) are associated with a Berkovic indenter, and equations represented by the following Formula (3) and Formula (5) are associated with a Vickers indenter and then stored.

$$\begin{matrix}[ Formula 3 ] & \\ {H}_{IT} = \frac{{F}_{max}}{{A}_{P} ( {h}_{C} )} & ( 3 )\end{matrix}$$

[Formula 4]

Aₚ(h_{C})=23.96h_{C}²+J₁h_{C}+J₂h_{C}^{1/2}+J₃h_{C}^{1/4}+J₄h_{C}^{1/8}+J₅h_{C}^{1/16}+J₆h_{C}^{1/32}+J₇h_{C}^{1/64}+J₈h_{C}^{1/128} (4)

[Formula 5]

Aₚ(h_{C})=24.50h_{C}²+J₁h_{C}+J₂h_{C}^{1/2}+J₃h_{C}^{1/4}+J₄h_{C}^{1/8}+J₅h_{C}^{1/16}+J₆h_{C}^{1/32}+J₇h_{C}^{1/64}+J₈h_{C}^{1/128} (5)

In this example, Fₘₐₓ(N) is the maximum test force. Aₚ(h_{c}) is a projected contact area between the indenter and the sample at maximum pressing. Also, J₁ to J₈ are the correction parameters.

FIG. 6 is a flow chart illustrating a hardness testing method of the hardness tester 100.

First, when the user mounts the indenter 3 on the indenter shaft 3a of the hardness tester 100, the connection terminals of the indenter 3 and the indenter shaft 3a are electrically connected (step S1).

Then, the CPU 11 executes the acquisition program 131 and acquires indenter information (the type of indenter, the correction parameters (J₁ to J₈)) stored in the indenter memory 33 of the indenter 3 (step S2).

Next, when the user provides an instruction input to the console 9 to perform hardness testing of the sample S, the CPU 11 executes the measurement program 132, then presses down on the surface of the sample S to form the indentation and measures the pressing indentation curve (step S3). Moreover, the instruction input from the user includes a designation of the type of hardness test (for example, Martens hardness (HM) or indentation hardness (H_{IT})) and test conditions corresponding to the hardness test are defined in response to the instruction input.

Next, the CPU 11 executes the hardness calculation program 133, selects an equation in response to the acquired indenter information (type of indenter), substitutes the acquired indenter information (correction parameters (J₁ to J₈)) into the selected equation, carries out the operation, and calculates the hardness (step S4).

According to the present embodiment, the hardness tester 100 loads a predetermined test force on the indenter 3 and presses into the surface of the sample S to form an indentation. The indenter 3 includes the indenter memory 33 storing indenter information specific to the indenter. The indenter 3 is detachably mounted to the indenter shaft 3a. The CPU 11 acquires, from the indenter memory 33, indenter information of the indenter 3 mounted to the indenter shaft 3a, and uses the acquired indenter information to perform a predetermined operation and calculate hardness. Therefore, in the hardness tester, indenter information of the mounted indenter 3 is read out and the hardness calculation is performed using the indenter information. Therefore, even in a case where the indenter 3 is used when mounted to a different hardness tester main body 1, hardness testing can be conducted without needing to register indenter information related to the indenter 3 on the hardness tester main body 1 after the change. Accordingly, in the hardness tester 100 using the detachable indenter 3, operability can be improved for the user when swapping out the indenter 3 for use.

In addition, according to the present embodiment, the indenter 3 includes the indenter main body 31 and the holder 32, which holds the indenter main body 31. The indenter memory 33 is installed within the holder 32. Therefore, when the forefront end portion of the indenter 3 becomes worn or damaged, it is only the indenter main body 31 (only a portion of the indenter 3) that is swapped out, thus enabling a reduction in costs.

Also, according to the present embodiment, the indenter information includes the correction parameters correcting the shape of the indenter 3 to the ideal shape in a predetermined operation, and the CPU 11 performs the predetermined operation using the acquired correction parameters. Therefore, even in a case where the tester main body 1 to be used is changed, hardness testing can be carried out without needing to register complex correction values on the tester main body 1 after the change.

In addition, according to the present embodiment, the type of the indenter 3 is included in the indenter information. The present embodiment includes the equation memory 134, which associates and stores the type of the indenter 3 with an equation calculating hardness. The CPU 11 selects an equation from the equation memory 134 in accordance with the acquired type of the indenter 3 and performs the predetermined operation. Therefore, an operation corresponding to the type of indenter can be carried out.

In the embodiment described above, an example is given of a Vickers hardness tester. However, the present invention can be applied to other hardness testers as well, such as a Rockwell hardness tester. Furthermore, a configuration is also possible in which the indenter information also includes, in addition to the type of indenter and correction parameters, a number of uses indicating a frequency of usage of the indenter 3, for example, and in which the correction parameters are updated in accordance with the number of uses.

In the embodiment described above, an example is given of a configuration storing equations in the memory 13 of the hardness tester 100. However, equations may instead be stored in the indenter memory 33.

Also, in the embodiment described above, an example is given of a configuration where the indenter 3 includes the indenter main body 31 and the holder 32. However, a configuration integrating the indenter main body 31 and the holder 32 is also possible.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A hardness tester for loading a predetermined test force on an indenter and pressing into a surface of a sample to form an indentation, the indenter including an indenter memory configured to store indenter information specific to the indenter, the hardness tester comprising:
an indenter mount configured to accept the indenter detachably mounted thereto;
an acquirer configured to acquire, from the indenter memory, the indenter information of the indenter mounted to the indenter mount; and
a hardness calculator configured to use the indenter information acquired by the acquirer, perform a predetermined operation, and calculate hardness.

2. The hardness tester according to claim 1, wherein:
the indenter includes an indenter main body and a holder configured to hold the indenter main body, and
the indenter memory is installed within the holder.

3. The hardness tester according to claim 1, wherein:
the indenter information includes correction parameters correcting a shape of the indenter to an ideal shape in the predetermined operation, and
the hardness calculator is further configured to perform the predetermined operation using the correction parameters acquired by the acquirer.

4. The hardness tester according to claim 2, wherein:
the indenter information includes correction parameters correcting a shape of the indenter to an ideal shape in the predetermined operation, and
the hardness calculator is further configured to perform the predetermined operation using the correction parameters acquired by the acquirer.

5. The hardness tester according to claim 1, wherein:
the indenter type is included in the indenter information,
the hardness tester further includes an equation memory associating and storing the indenter type with an equation calculating hardness, and
the hardness calculator is further configured to select an equation from the equation memory in accordance with the indenter type acquired by the acquirer and perform the predetermined operation.

6. The hardness tester according to claim 2, wherein:
the indenter type is included in the indenter information,
the hardness tester further includes an equation memory associating and storing the indenter type with an equation calculating hardness, and
the hardness calculator is further configured to select an equation from the equation memory in accordance with the indenter type acquired by the acquirer and perform the predetermined operation.

7. The hardness tester according to claim 3, wherein:
the indenter type is included in the indenter information,
the hardness tester further includes an equation memory associating and storing the indenter type with an equation calculating hardness, and
the hardness calculator is further configured to select an equation from the equation memory in accordance with the indenter type acquired by the acquirer and perform the predetermined operation.

8. The hardness tester according to claim 4, wherein:
the indenter type is included in the indenter information,
the hardness tester further includes an equation memory associating and storing the indenter type with an equation calculating hardness, and
the hardness calculator is further configured to select an equation from the equation memory in accordance with the indenter type acquired by the acquirer and perform the predetermined operation.

9. An indenter used in a hardness tester, the indenter comprising an indenter memory configured to store indenter information specific to the indenter, wherein the indenter is detachable with respect to the hardness tester

10. The indenter according to claim 9, further comprising:
an indenter main body; and
a holder configured to hold the indenter main body, wherein the indenter memory is installed within the holder.

11. The indenter according to claim 9, wherein the indenter information includes correction parameters correcting a shape of the indenter to an ideal shape in a predetermined operation calculating hardness.

12. The indenter according to claim 10, wherein the indenter information includes correction parameters correcting a shape of the indenter to an ideal shape in a predetermined operation calculating hardness.

13. The indenter according to claim 9, wherein the indenter information includes the indenter type.

14. The indenter according to claim 10, wherein the indenter information includes the indenter type.

15. The indenter according to claim 11, wherein the indenter information includes the indenter type.

16. The indenter according to claim 12, wherein the indenter information includes the indenter type.
